(19) United States
(12) Patent Application Publication
(10) Pub. No.: US 2007/0159543 A1
(43) Pub. Date: Jul. 12, 2007

(54) Simplified image sensor module package

(76) Inventor: Chung Hsien Hsin, Hsinchu Hsien (TW)

Correspondence Address: PRO-TECHTOR INTERNATIONAL SERVICES, 20775 NORADA CT., SARATOGA, CA, 95070, US

(21) Appl. No.: 11/317,070

(22) Filed: Dec. 22, 2005

(51) Int. Cl. H04N 9/04

(52) U.S. Cl. 348/273

(57) ABSTRACT

A simplified image sensor module package includes a flexible print circuit board having an upper surface, which is formed with a plurality of electrically circuits, and a lower surface. A frame layer is arranged on the upper surface of the flexible print circuit board. A chip is mounted on the upper surface of the flexible print circuit board. A plurality of wires are electrically connected the chip to the electrical circuits of the flexible print circuit board. A transparent layer is mounted on the frame layer to cover the chip. A lens holder is mounted on the frame layer, and formed with an internal thread. A lens barrel is formed with an external thread screwed on the internal thread of the lens holder.

### BACKGROUND OF THE INVENTION

1. Field of the Invention

The invention relates a simplified image sensor module package, and particular to a structure for packaging image sensor module, the size of the package may be decreased, and the manufacturing cost may be decreased.

2. Description of the Related Art

Referring to FIG. 1, it is an image sensor module structure includes a substrate 10, frame layer 18, a chip 26, a plurality of wires 28, transparent layer 34, a lens holder 35 and a lens barrel 46.

The substrate 10 has an first surface 12 on which plurality of first electrodes 15 are formed, and a second surface 14 on which plurality of second electrodes 16 are formed, the first electrodes 15 are corresponding to electrically connect to the second electrodes 16.

The frame layer 18 has a upper surface 20 and a lower surface 22, the lower surface 22 of the frame layer 18 is adhered on the first surface 22 of the substrate 10 to form a cavity 24.

The chip 26 is arranged on the first surface 12 of the substrate 10, and is located within the cavity 24, and is formed with bonding pads 27.

The wire 28 has a first end 30 and a second end 32, the first end 30 is electrically connected the bonding pad 27 of the chip 26, the second end 30 is electrically connected the first electrodes 15 of the substrate 10.

The transparent layer 34 is adhered on the upper surface 20 of the frame layer 18.

The lens holder 35 has an upper end surface 36, a lower end surface 40, and a penetrated region 42, which is formed with internal thread 44.

The lens barrel 46 is formed with external thread 39 screwed on the internal thread 44 of the lens holder 35, an opening 47, an aspheric lens 481, and an infrared filter 49.

Please refer to FIG. 2, the substrate 10 is mounted on a flexible print board 55, the second electrodes 16 of the substrate 10 are electrically connected to the flexible print board 55, therefore, the module is used to connect to a electrical device by the flexible print board 55.

### SUMMARY OF THE INVENTION

An objective of the invention is to provide a simplified image sensor module package, and capable of decreasing the size of the module.

Another objective of the invention is to provide a simplified image sensor module package, and capable of decreasing the manufacturing cost of the module.

To achieve the above-mentioned object, the invention includes a flexible print circuit board having an upper surface, which is formed with a plurality of electrically circuits, and a lower surface. A frame layer is arranged on the upper surface of the flexible print circuit board. A chip is mounted on the upper surface of the flexible print circuit board. A plurality of wires are electrically connected the chip to the electrical circuits of the flexible print circuit board. A transparent layer is mounted on the frame layer to cover the chip. A lens holder is mounted on the frame layer, and formed with an internal thread. A lens barrel is formed with an external thread screwed on the internal thread of the lens holder.

### BRIEF DESCRIPTION OF THE DRAWINGS

FIG. 1 is a cross-sectional view illustration showing a conventional image sensor module package.

FIG. 2 is a schematic illustration showing a conventional image sensor module package.

FIG. 3 is a cross-sectional view illustration showing a simplified image sensor module package of the present invention.

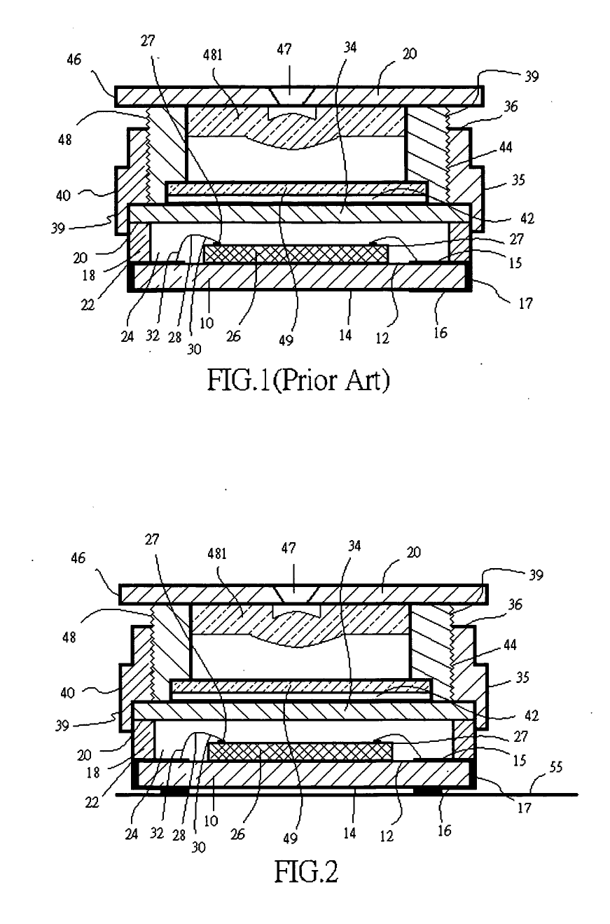

### DETAILED DESCRIPTION OF THE INVENTION

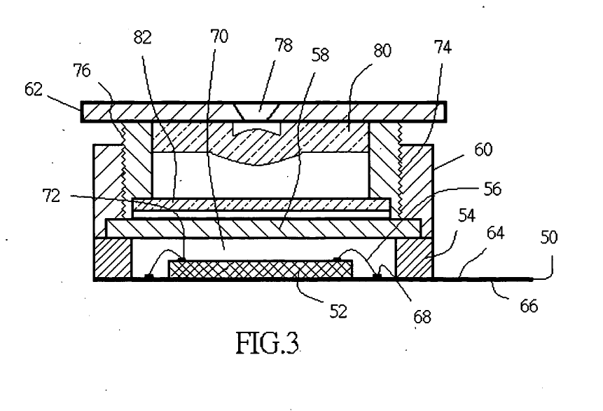

Please refer to FIG. 3, a simplified image sensor module package includes a flexible print board 50, a chip 52, a frame layer 54, wires 56, a transparent layer 58, a lens holder 60, and a lens barrel 62.

The flexible print circuit board 50 has an upper surface 64, which is formed with a plurality of electrical circuits 68, and a lower surface 66.

The frame layer 54 is arranged on the upper surface 64 of the flexible print board 50 to form a cavity 70.

The chip 52 is mounted on the upper surface 64 of the flexible print board 50, and located within cavity 70. The plurality of bonding pads 72 is formed on the chip 52.

The plurality of wires 56 are electrically connected the bonding pads 72 of the chip 52 to the electrically circuit 68 of the flexible circuit board 50.

The transparent layer 58 is mounted on the frame layer 54 to cover the chip 52.

The lens holder 60 is mounted on the frame layer 54, and formed with an internal thread 74. And

The lens barrel 62 is formed with an external thread 76 screwed on the internal thread 74 of the lens holder 60, and an opening 78, an aspheric lens 80, and an infrared filter 82.

While the invention has been described by the way of an example and in terms of a preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

What is claimed is:

1. A simplified image sensor module package, the package comprising;
a flexible print circuit board having an upper surface, which is formed with a plurality of electrically circuits, and a lower surface;
a frame layer arranged on the upper surface of the flexible print circuit board to form a cavity;
a chip mounted on the upper surface of the flexible print circuit board and located within the cavity;
a plurality of wires electrically connected the chip to the electrical circuits of the flexible print circuit board;
a transparent layer mounted on the frame layer to cover the chip;
a lens holder mounted on the frame layer, and formed with an internal thread; and
a lens barrel formed with an external thread screwed on the internal thread of the lens holder.

2. The simplified image sensor module package according to claim 1, wherein the lens barrel is formed with an opening, an aspheric lens, and an infrared filter.
